(19) United States
(12) Patent Application Publication
(10) Pub. No.: US 2005/0203805 A1
(43) Pub. Date: Sep. 15, 2005

(54) System and method for monitoring and controlling printing services for a printer

(76) Inventors: James E. Clough, Meridian, ID (US); Steve R. Wiley, Boise, ID (US)

Correspondence Address: HEWLETT-PACKARD COMPANY;Intellectual Property Administration, P.O. Box 272400, Fort Collins, CO, 80527-2400, US

(21) Appl. No.: 10/888,331

(22) Filed: Jul. 8, 2004

Related U.S. Application Data
(60) Provisional application No. 60/552,261, filed on Mar. 11, 2004.

(51) Int. Cl. G06F 17/60

(52) U.S. Cl. 705/26

(57) ABSTRACT

A system and method are provided for monitoring and controlling printing services for a printer using an Internet server. The method includes the step of sending a print job from a client computing device to the printer via the Internet server. The print job can be intercepted as the print job is received by the Internet server. Another step is identifying the client computing device sending the print job using the Internet server. A billing mechanism can be determined at the Internet server for the client computing device sending the print job. A further step is transmitting the print job from the Internet server to the printer to be printed.

This non-provisional application claims priority to U.S. Application No. 60/552,261 filed on Mar. 11, 2004.

### FIELD OF THE INVENTION

The present invention relates generally to monitoring and controlling printing services for a printer.

### BACKGROUND

The use of personal computers, laptops, and personal digital assistants (PDAs) has become more widespread than ever before. Not only do personal computer users use their laptops and PDAs in a business or home environment, but they also use these devices in other public environments. For example, computer users may need to use their laptops in public areas such as hotels, restaurants, coffee shops, and similar public venues. When computers are used in these venues, computer users desire to have certain services such as an Internet connection and the ability to print documents or presentations.

In a public environment, a printing system that provides public printing services is more valuable if the printing system is able to limit access to the printing services to authorized users. Controlling access to the printer to enforce payment for print jobs is beneficial to a business. Some proprietary print services exist that control public printing and provide a way for payment to be made for those services. In a hotel environment, print job requests that originate from a guest room can be automatically billed to that room using proprietary printer drivers and proprietary printer server software. Requests from other locations within the hotel or restaurant can be billed manually.

When the proprietary printer server that is separate from the printer can determine the identity of a guest in a hotel or coffee shop, then the server can use this information to determine how to bill for the printing services. In the past, at least two different approaches were provided for identifying a user for billing. One solution has been to provide an integrated public printing service. As mentioned, such integrated services use a proprietary printing infrastructure where the printer server that controls access to the printing services to use the printing service can download the proprietary client software and install the proprietary printer driver to perform printing. Such proprietary systems are expensive due to the development and maintenance costs. In addition, a proprietary system can be more complex and difficult to deploy.

Another drawback to a proprietary printing control system is the inconvenience from the user's side when they have to identify and download the proprietary client software and drivers. Then if the user cannot make the client printer driver software function properly, the user may need to contact software support or, in the worst case scenario, the user will not be able print at all.

An alternative solution to a proprietary system is to allow the user or guest to bill the printing through a server setup in advance by personnel at the establishment. For example, the printing services can query the guest as to whether they have an account or if they are in a room in the hotel. Then the user can provide identification such as a credit card, a pin number, or some other account identification to authorize the posting of charges to the account or room. This is relatively inconvenient for the guest. It is also inconvenient to the hotel or restaurant staff who administer the accounts.

A different solution is to make every print job billing a manual billing. Examples of manual billing include paying by credit card or bringing cash when a user picks up a print job from a printing services attendant. Alternatively, the hotel or restaurant staff can manually enter the printing charges into the hotel invoice system. This type of solution is relatively expensive in terms of labor costs and manual billing is also inconvenient.

### SUMMARY OF THE INVENTION

A system and method are provided for monitoring and controlling printing services for a printer using an Internet server. The method includes the step of sending a print job from a client computing device to the printer via the Internet server. The print job can be intercepted as the print job is received by the Internet server. Another step is identifying the client computing device sending the print job using the Internet server. A billing mechanism can be determined at the Internet server for the client computing device sending the print job. A further step is transmitting the print job from the Internet server to the printer to be printed.

### BRIEF DESCRIPTION OF THE DRAWINGS

FIG. 1 is a flow chart illustrating an embodiment of a method for monitoring and controlling printing services for a printer using an Internet server;

FIG. 2 is a block diagram of a system for monitoring and controlling printing services for a printer on a computer network, in accordance with an embodiment of the present invention; and

FIG. 3 is a block diagram of a system for monitoring and controlling printing services for a printer on a computer network using an accounting server, in accordance with an additional embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

A system and method are provided for monitoring and controlling printing services for a printer using an Internet server. As discussed above, there are several problems associated with proprietary print server and print accounting systems that use proprietary printer drivers. Accordingly, the present invention provides a printing system that can monitor and control printing services with an Internet server in a public environment without the need for a user to load specialized or custom software drivers.

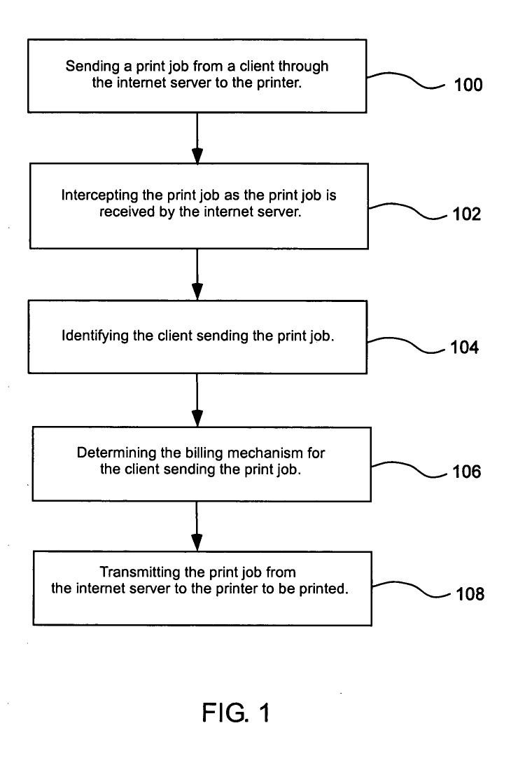

FIG. 1 illustrates an operation in the present method for sending a print job from a client computing device to the printer via an Internet server in block 100. The print job will be sent from the client computing device using a non-proprietary printer driver. The non-proprietary printer drivers can be printer drivers supplied with the operating system or other generic printer drivers that can interoperate with the specific printer receiving the print job. An example of a printer driver that may be used is a universal printer driver from Microsoft Corporation or Hewlett-Packard Development Company that can print to multiple printing services or printers.

Another operation in the present method is intercepting the print job as the print job is received by the Internet server as in block 102. Because the client computing device accesses the network and Internet on a paid basis through the Internet server, the network packet traffic from the client device passes through the Internet server. This allows the print job to be identified and intercepted by the Internet server. Then the client computing device sending the print job can be identified using the Internet server as in block 104.

There are a number of techniques for identifying the client computing device using the Internet server. One technique is that the Internet server can determine the physical location of the guest from the network port the guest is using. This can be done using intelligent switches with port tracking and naming intelligence (e.g., layer 3 intelligence). For example, the Internet server can interpret a default port name or no port name on the network to mean that the client computing device is not at a location from which print jobs can be accepted and billed. In contrast, any requests from a client computing device through a port with a port name can be identified as a billable location and the port name can be identified.

Alternatively, ports may have a specific naming convention that the Internet server can identify as non-billable and other ports may have a naming convention that the Internet server can identify as billable to a specific room or account configuration. In addition, ports that correspond to billable locations in the public facility can be prefixed with a known or configurable set of characters. A mask can be used to identify the specially prefixed characters for the specific port. The Internet server may parse the port name associated with a print job request to determine how to bill for the print job. In addition, a more detailed scheme for port identification can be used, such as one based on regular expressions.

An advantage of using configurable port values is that the Internet server can identify these configurable port values and the port names can be changed as necessary to fit into the port naming practices used in each establishment. Another advantage of configurable ports is that the printer does not need to know how to map network ports to physical locations. The mapping of the physical ports can be done when the ports are named. Thus, this physical identification scheme helps avoid prompting guests for billing information during the printing process.

Another approach is the client computing device can request an Internet Protocol (IP) address from the Internet server when it first connects through the hardware port to the Internet server. This generally occurs when the client computing device requests the Internet services. This IP address can be used for the duration of time the client computing device is connected to the Internet server and thus the IP address can identify the client computing device. An example of when the Internet server can supply an IP address is when a user connects to an Internet server for Internet services in a hotel, coffee shop, restaurant, a café, retail shopping area, or some other public place. The IP address is usually supplied at network connect, but traffic from that address is blocked at the Internet server. The client generally uses an IP address in order to interact with the payment service. When the user pays for Internet access, the block is removed until the paid time expires or the client disconnects from the network.

Another way in which the client computing device can be identified is by using a unique identifier from the client computing hardware. Some identifiers that can be used are the client computer's network card hardware address or a media access control (MAC) address from a selected hardware component in the client computing device. Yet another way of identifying the client computing device is to require all the client computing devices to communicate through one or more defined subnets. When a subnet is identified, then the specific device that is restricted to paid printing can be identified and the specific address within the subnet will identify the client computing device.

When the client computing device has been identified, then the billing mechanism for the client sending the print job can be determined as in block 106. The Internet server can confirm that the client computing device and user sending the print job have a way to pay for the printing that will be performed. If no billing mechanism or information exists for the client computing device, then an error may be returned to the client computing device and the print job will not be printed until a billing mechanism is setup or identified.

Once a billing mechanism has been determined by the Internet server, then the print job can be transmitted from the Internet server to the printer to be printed, as depicted in block 108. In order to bill the user of the client computing device, the Internet server may determine a total page count for the printer by sending a hardware management protocol requests or queries to the printer. In response, the printer can reply to the Internet server with the current total page count. Thus, the final page count can be subtracted from the original page count and the number of pages that have been printed can be calculated. In one embodiment of the invention, simple network management protocol (SNMP) can be used by the Internet server to request page counts from the printer. The number of pages printed can then be charged to the user or owner of the client computing device by charging it to a hotel bill, a credit card, or some other billing account. If the billing is for a hotel, then the hotel room number associated with the network port, assigned IP address, or MAC address can be used to identify the billing account. This allows the hotel to bill print requests that originate from a guest room to the room number automatically.

In order to help users of the client computing devices to find their print jobs, a banner page can be sent identifying the client computing device or hardware port (e.g., hotel room) sending the print job. This banner can be transmitted with the print job to separate the print jobs from each other. Using an Internet server to control printing services allows hotels, coffee shops, restaurants, or other establishments to offer easy-to-use printing services to guests and this helps generate revenue for the establishment.

The present invention avoids the problem where the printer cannot determine which client computing device a request came from, and then the printer assumes that a manual billing is required for that job. As a result, this invention also avoids the situation where an individual who is working at an establishment is needed to manually bill prints jobs.

Another benefit of the present invention is that users of the client computing device can generally avoid interacting with a proprietary printing system. The Internet server can avoid interacting with the user when the printer job can be identified by the network port and hotel room. This avoids usability and customer support problems which can deter guests from using the service. When the hotel or retail property has an Internet server that can determine the physical location of a client computing device on the public network, then the Internet server can use this information to determine how to bill for the printer's services.

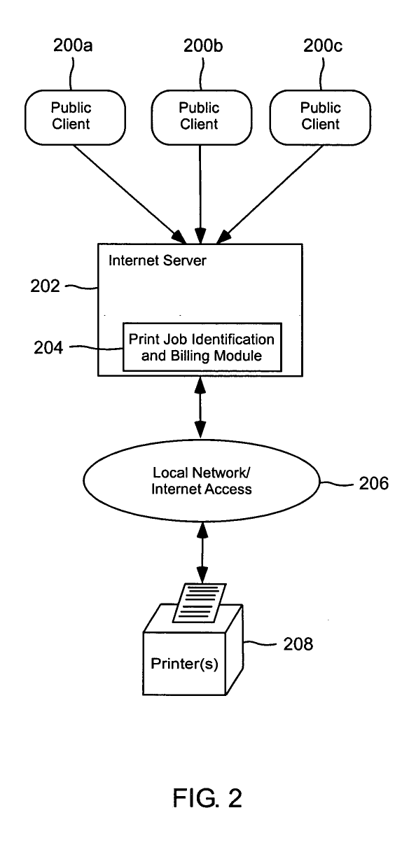

FIG. 2 illustrates an embodiment of a system for monitoring and controlling printing services on a computer network. The system includes a plurality of client computing devices 200a, 200b, and 200c that are configured to print through the local computer network 206. The client computing devices may be any type of computing device which can send a print job through the network. For example, a client computing device can be a desktop computer, a laptop computer, a personal digital assistant (PDA), a web enabled phone or any other computing device that can generate a print job. One or more printers 208 are also included for printing the print jobs. The printer can be any of a number of available printer types such as a laser jet printer, an ink jet printer, a sublimation printer, a copier, or another printing device.

An Internet server 202 is in communication with the client computing devices 200a-c and the computer network 206. The Internet server is defined generally here as a server or router that allows an establishment to provide Internet services on their property and enables or disables access to the Internet for the client devices. This server may provide a relatively high speed Internet connection which is desired by computer users in resorts, hotels, restaurants, and other locations. For example, the Internet server can provide Internet access to guest rooms, conference rooms, and a hotel's computer network. Billing and account management can also be done through the Internet server and this may be performed using custom web pages and/or applications.

The plurality of client computing devices will connect to the Internet through the Internet server. Thus, the Internet server becomes a conduit for communications with the outside networks and printers. When the Internet server captures print jobs before they pass to the outside network, it acts as a controller to monitor, regulate, and bill the printing jobs that are being requested.

One or more target printers 208 are configured to receive print jobs from the client computing devices via the Internet server 202. A print job identification module 204 can also be associated with the Internet server. The print job identification and billing module 204 can be located in the Internet server as part of the software, firmware, or hardware. Alternatively, the print job identification module 204 can be a separate hardware unit that is in electronic communication with the Internet server. The print job identification module 204 is configured to identify print jobs from the client computing devices 200a-c. The Internet server can use the print job identification module to recognize the messages, packets, or ports that contain information destined for the printers 208.

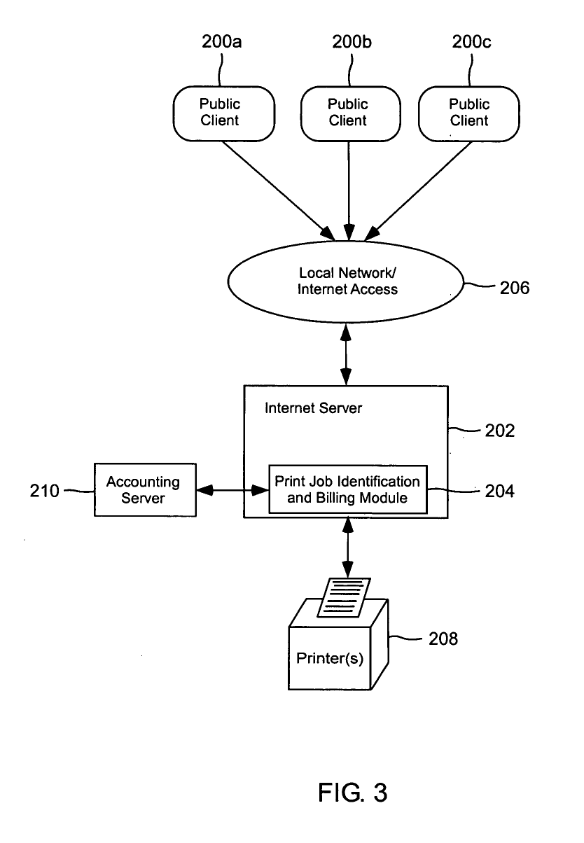

The print job identification module 204 may also include a billing module. Thus, the print job identification and billing module 204 can determine the billing method for the client computing devices. If a user of the client computing device has an available billing method then the Internet server and print job identification module 204 can authorize the printing of print jobs. Billing method availability may depend upon whether the Internet server can identify a port or physical address for the client device. If the physical location of the client device can be determined then the hotel room or specific account for a user of the client computing device can be billed. The billing information can also be sent to a separate accounting server 210 if desired, as illustrated in FIG. 3.

One possible implementation of the invention will now be described. The owner of a public Internet server can provide a web page for guests or visitors to learn about the public printing solution and obtain or download a universal print driver. One example of a universal print driver is a mobile printing driver from the Hewlett-Packard Development Company. This mobile printer driver can be used with many types of printers and is configured to communicate in many printer languages.

Once a guest has installed the mobile printer driver, the guest will print using the universal printer driver and enter a destination identifier such as “mobile.printing” or some other identifiable name into the destination dialog box of the universal printer driver. The universal print driver resolves the identifier (ie. mobile.printing or another name supplied on the web page) to the IP address of the printer that is accessible through the Internet server. Of course, multiple printers can be supported using multiple DNS names.

The universal printer driver can then contact the printer via SNMP (Simple Network Management Protocol) and/or HTTP (Hypertext Transfer Protocol) on a web port (e.g., port 80) to identify the printer and obtain an XML description or some other electronic description of the printer features. These printer features can then be presented to the guest or user through the client computing device.

The universal printer driver can send the print job to the printer through, for example, port 9100 when requested by a user. The Internet server can intercept the port 9100 data stream and detect the client computing device which is sending the job. The use of port 9100 is not limiting because any port number or group of ports can be used to transfer the print job from the client computing device.

The print job can be recognized and intercepted by the Internet server. Then the Internet server will determine whether there is way to bill the print job that was received. If there is a way to bill the print job, then the print job may be forwarded to the printer for printing. The Internet server can also generate and send a banner page to the printer on port 9100 and then send the intercepted print job data to the printer following the banner page.

The Internet server can query the printer via SNMP to determine when the print job has completed. At this point, the final page count can be retrieved from the printer. The Internet server subtracts the initial page count and one page for the banner page from the final page count to determine the number of pages that will be billed to the user or guest. In addition, the user will be billed for the pages printed through their hotel room account or some other account.

In another embodiment, it can be beneficial to configure the public printer to only accept print jobs from the Internet server. This can prevent unauthorized users printing to the printer, even if they are able to circumvent the Internet server to get to the network. The Internet server may spool jobs or stream then directly to the printer depending on the printer and Internet server configuration.

The use of a universal printer driver is beneficial because the universal printer driver allows a guest who has already downloaded and used a universal print driver to use the print solution again at another location without being presented setup information. In this situation, the user can send a print job without ever being presented with the cost per page or any login information because they have already installed the universal print driver on their client computing device. Of course, the pages printed are billed to their hotel room, guest account, or other arranged billing method. The use of a universal print driver is just for convenience and is not required. The client can just as easily set up an ordinary print queue to print to the printer and the present invention would work in the manner described above.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

1. A method for monitoring and controlling printing services for a printer using an Internet server, comprising the steps of:
sending a print job from a client computing device to the printer via the Internet server;
intercepting the print job as the print job is received by the Internet server;
identifying the client computing device sending the print job by using the Internet server;
determining a billing mechanism at the Internet server for the client computing device sending the print job; and
transmitting the print job from the Internet server to the printer to be printed.

2. A method as in claim 1, further comprising the step of determining a total page count for the printer using a management protocol request from the Internet server.

3. A method as in claim 2, further comprising the step of determining a total page count for the printer using simple network management (SNMP) protocol with the Internet server.

4. A method as in claim 1, wherein the step of determining a billing mechanism further comprises the step of billing a user of the client computing device based on the billing mechanism determined.

5. A method as in claim 4, wherein the step of billing a user further comprises the step of billing a user of the client computing device by hotel room number.

6. A method as in claim 4, wherein the step of billing a user further comprises the step of billing a user of the client computing device using a user's account.

7. A method as in claim 4, wherein the step of billing a user further comprises the step of billing a user of the client computing device through a user's credit card.

8. A method as in claim 1, further comprising the steps of:
generating a banner page identifying the client computing device sending the print job; and
transmitting the print job to the printer with the banner page pre-pended to the print job.

9. A method as in claim 1, further comprising the step of calculating a total page count at the completion of the print job using information received by the Internet server.

10. A method as in claim 9, further comprising the step of billing a user of the client computing device based on the total page count.

11. A method as in claim 1, further comprising the step of enabling any client device having a universal printer driver to send print jobs to the Internet server.

12. A method as in claim 1, further comprising the step of sending the print job from the client device using non-proprietary client printing software.

13. A method as in claim 1, wherein the step of identifying the client computing device sending the print job by using the Internet server further comprises the step of identifying an address of the client computing device sending the print job by using the Internet server.

14. A method as in claim 1, wherein the step of identifying the client computing device sending the print job by using the Internet server further comprises the step of identifying a network card address of the client computing device sending the print job by using the Internet server.

15. A method as in claim 1, wherein the step of identifying the client computing device sending the print job by using the Internet server further comprises the step of identifying the client computing device sending the print job by using a subnet address.

16. A system for monitoring and controlling printing services on a computer network, comprising:
a plurality of client computing devices configured to print through the computer network;
an Internet server in communication with the plurality of client computing devices and the computer network, the Internet server being configured to intercept print jobs from the plurality of client computing devices;
a printer configured to receive print jobs from the client computing devices via the Internet server; and
a print job identification module associated with the Internet server, the print job identification module being configured to identify print jobs from the client computing devices, determine a billing method for the client computing devices, and authorize printing of print jobs when a billing method is available.

17. A system as in claim 16, further comprising a billing module associated with the Internet server, the billing module being configured to bill a user of a client computing device for completed print jobs.

18. A system as in claim 16, wherein the Internet server is a broadband Internet server.

19. A system as in claim 16, wherein the Internet server includes a network port in order to receive print jobs.

20. A system as in claim 16, wherein the Internet server is configured to receive print jobs from a group of subnet addresses.

21. A system for monitoring and controlling printing services on a computer network, comprising:
a plurality of client computing means for sending print jobs through the computer network;
an Internet server means in communication with the plurality of client computing means and the computer network, the Internet server means being for intercepting print jobs from the plurality of client computing means;
a printer means for receiving print jobs from the client computing means via the Internet server; and
a print job identification means associated with the Internet server means, the print job identification means being for identifying print jobs from the client computing means, determining a billing method for the client computing means, and authorizing printing of print jobs when a billing method is available.

22. A system as in claim 21, further comprising a billing module means associated with the Internet server, configured to bill a user of a client computing means for completed print jobs.

23. An article of manufacture, comprising:
a computer usable medium having computer readable program code embodied therein for monitoring and controlling printing services for a printer using an Internet server, the computer readable program code means in the article of manufacture comprising:
computer readable program code for sending a print job from a client computing device to the printer via the Internet server;
computer readable program code for intercepting the print job as the print job is received by the Internet server;
computer readable program code for identifying the client computing device sending the print job by using the Internet server;
computer readable program code for determining a billing mechanism at the Internet server for the client computing device sending the print job; and
computer readable program code for transmitting the print job from the Internet server to the printer to be printed.
